(19) United States
(12) Patent Application Publication
(10) Pub. No.: US 2012/0231350 A1
(43) Pub. Date: Sep. 13, 2012

(54) Solid Battery

(75) Inventors: Kunio Nishida, Nagaokakyo-Shi (JP); Hitomi Nishida, Nagaokakyo-shi (JP); Takafumi Iwaguchi, Nagaokakyo-shi (JP); Masutaka Ouchi, Nagaokakyo-Shi (JP); Makoto Yoshioka, Nagaokakyo-Shi (JP); Takeshi Hayashi, Nagaokakyo-Shi (JP)

(73) Assignee: Murata Manufacturing Co., Ltd., Nagaokakyo-Shi (JP)

(21) Appl. No.: 13/477,136

(22) Filed: May 22, 2012

Related U.S. Application Data
(63) Continuation of application No. PCT/JP2010/070958, filed on Nov. 25, 2010.

(30) Foreign Application Priority Data
Nov. 27, 2009 (JP) 2009-270429

(51) Int. Cl. H01M 4/485

(52) U.S. Cl. 429/322

(57) ABSTRACT

A solid battery that includes a positive electrode layer, a negative electrode layer, and a solid electrolyte layer. The positive electrode layer and the negative electrode layer include an electrode active material. The solid electrolyte layer includes a solid electrolyte. A LiZr₂(PO₄)₃-containing layer is provided between the solid electrolyte layer and at least one of the positive electrode layer and the negative electrode layer.

### CROSS REFERENCE TO RELATED APPLICATIONS

The present application is a continuation of International application No. PCT/JP2010/070958, filed Nov. 25, 2010, which claims priority to Japanese Patent Application No. 2009-270429, filed Nov. 27, 2009, the entire contents of each of which are incorporated herein by reference.

### FIELD OF THE INVENTION

The present invention relates to a solid battery.

### BACKGROUND OF THE INVENTION

In recent years, batteries, particularly secondary batteries, have been used as a power supply for portable electronic devices, such as portable telephones and personal computers. One example of the secondary battery is a lithium ion secondary battery, which is known to have a relatively high energy density. In such a secondary battery, as a medium for moving ions, a liquid electrolyte of organic solvent (electrolytic solution) may be conventionally used. However, in the secondary battery using such electrolytic solution, there is the problem of leakage of the electrolytic solution, for example. Thus, development of a solid battery is underway in which all of the constituent elements are composed of solid material by using a solid electrolyte.

As the solid electrolyte used in the solid battery, compounds having a NASICON-type structure are being studied. Of the compounds having the NASICON-type structure, JP-A-2009-140910 (Patent Document 1) and JP-A-2009-224318 (Patent Document 2) discuss Li₁₊ₓAlₓTi₂₋ₓ(PO₄)₃ (hereafter referred to as “LATP”) and Li₁₊ₓAlₓGe₂₋ₓ(PO₄)₃ (hereafter referred to as “LAGP”), which are known as solid electrolytes that exhibit relatively high ionic conductivity on the order of 1×10⁻⁴ S/cm at room temperature.

Patent Document 1: JP-A-2009-140910

Patent Document 2: JP-A-2009-224318

### SUMMARY OF THE INVENTION

However, the above compounds are easily reduced. Particularly, LATP is known to be reduced at the potential of 2.45 V (vs Li/Li⁺) in an electrolytic solution. The low reduction resistance of the compounds makes it difficult to realize a solid battery. While LAGP is known to be difficult to be reduced compared to LATP, the reduction resistance of LAGP is not necessarily sufficient.

Various types of electrode active material for the solid battery are also being studied. A representative example of the electrode active material is a lithium-titanium composite oxide of a spinel-type structure, or Li₄Ti₅O₁₂ (hereafter referred to as “LTO”), which is believed to be capable of producing a relatively high battery voltage and easily applicable to the solid battery. It is known that the reduction potential of LTO is relatively high at 1.5 V (vs Li/Li⁺). When a solid battery is constructed by using LTO as an electrode active material in combination with a solid electrolyte, stability of the battery may not be ensured.

In order to increase the energy density of a solid battery, it may be effective to form ion conduction paths by having the solid electrolyte and the electrode active material contained in each of a positive electrode layer and a negative electrode layer. However, when such a structure is adopted, the area of contact between the electrode active material and the solid electrolyte increases, resulting in the manifestation of the problem of low reduction resistance of the solid electrolyte. Thus, development of a solid electrolyte having high reduction resistance may be desirable.

Thus, an object of the present invention is to provide a solid battery whose stability is increased by improving the reduction resistance of solid electrolyte.

In order to solve the problems of the related art, through their extensive research, the inventors conducted an analysis of the reduction resistance of a solid electrolyte by first-principles calculation. The analysis indicates that the reduction resistance of the solid electrolyte can be improved by interposing LiZr₂ (PO₄)₃ (hereafter referred to as “Zr-NASICON”) between an electrode active material and a solid electrolyte. Specifically, reduction of the solid electrolyte by the electrode active material can be restrained by interposing the Zr-NASICON between the electrode active material and the solid electrolyte. Based on this finding, a solid battery according to various aspects of the present invention may provide the following features.

A solid battery according to one aspect of the present invention includes a positive electrode layer, a negative electrode layer, and a solid electrolyte layer. The positive electrode layer and the negative electrode layer include an electrode active material. The solid electrolyte layer includes a solid electrolyte. A LiZr₂(PO₄)₃-containing layer is provided on at least a part of a surface of the solid electrolyte included in the solid electrolyte layer.

In the solid battery according to the one aspect of the present invention, because the LiZr₂(PO₄)₃-containing layer is provided on at least a part of the surface of the solid electrolyte included in the solid electrolyte layer, the LiZr₂(PO₄)₃-containing layer is present between the electrode active material included in the positive electrode layer or the negative electrode layer and the solid electrolyte included in the solid electrolyte layer. Thus, reduction of the solid electrolyte by the electrode active material can be restrained. As a result, a solid battery having high stability can be manufactured.

Preferably, in the solid battery according to the one aspect of the present invention, the LiZr₂(PO₄)₃-containing layer is provided between the solid electrolyte layer and at least one of the positive electrode layer and the negative electrode layer.

In this case, because the LiZr₂(PO₄)₃-containing layer is present between the solid electrolyte layer and at least one of the positive electrode layer and the negative electrode layer, reaction at an interface between the solid electrolyte layer and at least one of the positive electrode layer and the negative electrode layer can be restrained, so that a solid battery having high stability can be obtained.

Preferably, in the solid battery according to the one aspect of the present invention, the solid electrolyte layer may include the solid electrolyte coated with the LiZr₂(PO₄)₃-containing layer.

In this case, the solid electrolyte layer may preferably include a first solid electrolyte layer including the solid electrolyte and a second solid electrolyte layer disposed between the first solid electrolyte layer and at least one of the positive electrode layer and the negative electrode layer, the second solid electrolyte layer including the solid electrolyte coated with the LiZr₂(PO₄)₃-containing layer.

Further preferably, in the solid battery according to the one aspect of the present invention, the positive electrode layer and the negative electrode layer may include the solid electrolyte.

A solid battery according to a second aspect of the present invention includes a positive electrode layer, a negative electrode layer, and a solid electrolyte layer. The positive electrode layer and the negative electrode layer include an electrode active material and a solid electrolyte. A LiZr₂(PO₄)₃-containing layer is provided on at least a part of a surface of at least one of the electrode active material and the solid electrolyte included in at least one of the positive electrode layer and the negative electrode layer.

In the solid battery according to the second aspect of the present invention, the LiZr₂(PO₄)₃-containing layer is provided on at least a part of the surface of at least one of the electrode active material and the solid electrolyte included in at least one of the positive electrode layer and the negative electrode layer. Thus, when an electrode layer is formed by mixing the solid electrolyte and the electrode active material, the LiZr₂(PO₄)₃-containing layer is present between the electrode active material and the solid electrolyte in at least one of the positive electrode layer and the negative electrode layer. Accordingly, reduction of the solid electrolyte by the electrode active material in at least one of the positive electrode layer and the negative electrode layer can be restrained. As a result, a solid battery having high stability can be manufactured.

Preferably, in the solid battery according to the second aspect of the present invention, the LiZr₂(PO₄)₃-containing layer may be present between the electrode active material and the solid electrolyte.

Preferably, in the solid battery according to the second aspect of the present invention, the surface of the electrode active material may be coated with the LiZr₂(PO₄)₃-containing layer.

Preferably, in the solid battery according to the second aspect of the present invention, the surface of the solid electrolyte may be coated with the LiZr₂(PO₄)₃-containing layer.

Preferably, in the solid battery according to the first or the second aspect of the present invention, the solid electrolyte may include at least one type of solid electrolytes having a NASICON-type structure expressed by a general expression Li₁₊ₓM^{I}ₓM^{II}₂₋ₓ(PO₄)₃, where M^{I} is Al or Ga, and M^{II} is Ti or Ge.

Preferably, in the solid battery according to the first or the second aspect of the present invention, the electrode active material may include at least one of a lithium-titanium composite oxide having a spinel-type structure and titanium oxide.

According to the present invention, by interposing a material including LiZr₂(PO₄)₃ between the solid electrolyte and the electrode active material, reduction resistance of a solid electrolyte can be improved. In other words, reduction of the solid electrolyte by the electrode active material can be restrained. Thus, a solid battery having high stability can be manufactured.

### BRIEF EXPLANATION OF THE DRAWINGS

FIG. 1 is a cross section schematically illustrating a structural example (a) of a solid battery according to Embodiment 1 of the present invention.

FIG. 2 is a cross section schematically illustrating a structural example (b) of the solid battery according to Embodiment 1 of the present invention.

FIG. 3 is a cross section schematically illustrating a structural example (c) of the solid battery according to Embodiment 1 of the present invention.

FIG. 4 is a cross section schematically illustrating a structural example (d) of the solid battery according to Embodiment 1 or a structural example (b) of a solid battery according to Embodiment 2 of the present invention.

FIG. 5 illustrates an example of constituent elements of a solid electrolyte layer of the solid battery according to Embodiment 1 or 2 of the present invention.

FIG. 6 illustrates another example of the constituent elements of the solid electrolyte layer of the solid battery according to Embodiment 1 or 2 of the present invention.

FIG. 7 illustrates an example of constituent elements of a positive electrode layer or a negative electrode layer of the solid battery according to Embodiment 1 of the present invention.

FIG. 8 illustrates another example of the constituent elements of the positive electrode layer or the negative electrode layer of the solid battery according to Embodiment 1 of the present invention.

FIG. 9 is a cross section schematically illustrating a structural example (a) of the solid battery according to Embodiment 2 of the present invention.

FIG. 10 illustrates an example of constituent elements of a positive electrode layer or a negative electrode layer of the solid battery according to Embodiment 2 of the present invention.

FIG. 11 illustrates another example of the constituent elements of the positive electrode layer or the negative electrode layer of the solid battery according to Embodiment 2 of the present invention.

FIG. 12 illustrates another example of the constituent elements of the positive electrode layer or the negative electrode layer of the solid battery according to Embodiment 2 of the present invention.

### DETAILED DESCRIPTION OF THE INVENTION

In the following, modes for carrying out the present invention will be described.

An electron structure of a solid electrolyte, particularly a solid electrolyte of the NASICON-type structure, such as LATP, LAGP, and Zr-NASICON, includes a valence band that mainly includes O2p and a conduction band that mainly includes the d orbital of a central metal element. The valence band is filled with electrons. The conduction band is devoid of electrons. As a result, there are no conduction electrons, and, therefore, the solid electrolyte of the NASICON-type structure is an insulator in terms of electrons. In a crystal of the NASICON-type structure, lithium ions can move and therefore electric conduction by ions is possible. Thus, movement of electrons and movement of ions can be separated, so that the crystal of the NASICON-type structure can provide the role of an electrolyte for a battery.

The reduction resistance of the solid electrolyte of the NASICON-type structure can be evaluated in terms of an electromotive force of a reaction of insertion of lithium ions into the solid electrolyte of the NASICON-type structure with respect to metallic lithium. When the electromotive force exhibits a high potential, insertion of lithium ions into the solid electrolyte readily occurs, and the solid electrolyte can be readily reduced. When the electromotive force is low, insertion of lithium ions into the solid electrolyte does not readily occur, and the solid electrolyte is difficult to be reduced.

The electromotive force of the battery can be measured by calculating the difference between a sum of the internal energy of the solid electrolyte and the metallic lithium prior to reaction and the internal energy in a reduced state where lithium ions are inserted after reaction.

TABLE 1

| | | OCV |
|---|---|---|
| System | Electrolyte | V vs Li |
| LTP | Li₂Ti₄(PO₄)₃ | 1.815 |
| LGP | Li₂Ge₄(PO₄)₃ | 0.963 |
| LZrP | Li₂Zr₄(PO₄)₃ | 0.571 |
| L(TiZr)P | Li₂Ti₂Zr₂(PO₄)₃ | 1.909 |

Table 1 illustrates the values of electromotive force (OCV) calculated in cases where the central metal of a solid electrolyte of the NASICON-type structure are changed to Ti, Ge, and Zr, and a case where the central metal is in a mixed state of Ti:Zr=1:1. As seen from Table 1, when the central metal is Ti, the electromotive force is large and the reduction resistance of the solid electrolyte is low. When the central metal is Zr, the electromotive force is small, so that it can be concluded that the reduction resistance of the solid electrolyte is high. When the central metal is Ge, the electromotive force is between that of Ti and that of Zr and the reduction resistance of the solid electrolyte is inferior to the case where the central metal is Zr.

Particular attention may be focused on the case where the central metal is in the mixed state of Ti and Zr. It is seen that, despite the Zr contained in the structure, the electromotive force is comparable to the case of the central metal being Ti, indicating that the Ti, which has low reduction resistance, controls the reducibility of the material.

As a result of the above analysis by first-principles calculation, it can be concluded that by using LiZr₂(PO₄)₃ instead of LATP or LAGP, a solid battery having no problem of reduction resistance can be obtained. However, when only LiZr₂(PO₄)₃ is used as the solid electrolyte of a solid battery, the melting temperature or decomposition temperature of many electrode active materials are exceeded by the high thermal processing temperature required for material synthesis of LiZr₂(PO₄)₃. Thus, selection of active material for the solid battery becomes difficult. Further, problems may be caused in the thermal processing step during the manufacture of the solid battery, making it difficult to manufacture an integral-type solid battery by sintering or baking.

In order to solve the problems encountered when only LiZr₂(PO₄)₃ is used as the solid electrolyte, LiZr₂(PO₄)₃ may be provided in a composite with an electrode active material or a solid electrolyte of the NASICON-type structure. For example, by interposing a material including LiZr₂(PO₄)₃ between the electrode active material and the solid electrolyte of the NASICON-type structure, the problems can be solved while LiZr₂(PO₄)₃ can be taken advantage of.

The material including LiZr₂(PO₄)₃ may be interposed between the solid electrolyte of the NASICON-type structure and the electrode active material by any method or means. The material including LiZr₂(PO₄)₃ may be coated or attached onto the solid electrolyte of the NASICON-type structure or the electrode active material by various methods. For example, fine particles of the electrode active material or the solid electrolyte of the NASICON-type structure and the material including LiZr₂(PO₄)₃ may be dispersively mixed mechanically by using a ball mill. In another method, a precursor layer of the material including LiZr₂(PO₄)₃ may be formed on the surface of the solid electrolyte of the NASICON-type structure or the electrode active material in advance by sol-gel method, so that synthesis of the material including LiZr₂(PO₄)₃ and formation of a surface layer can be performed simultaneously during the co-firing of the battery.

In the following, embodiments of the present invention will be described with reference to the drawings.

### Embodiment 1

### Embodiment 1-a

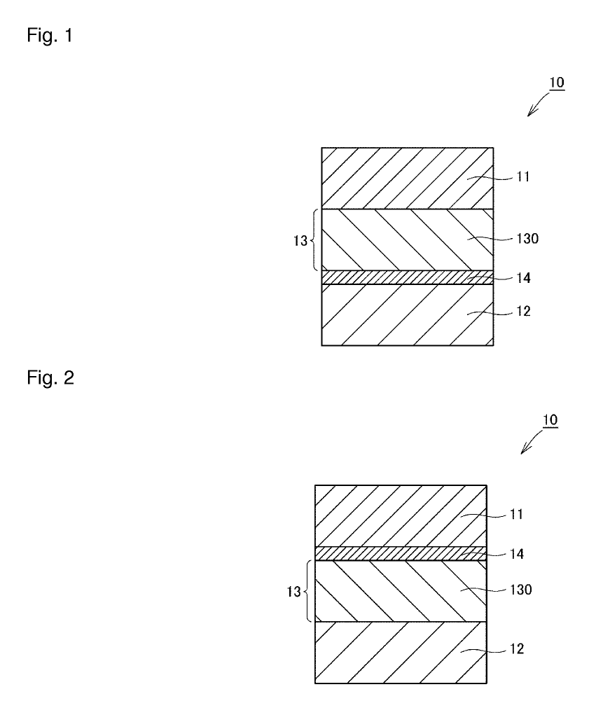

As illustrated in FIG. 1, in a structural example (a) of the solid battery according to Embodiment 1 of the present invention, a solid battery 10 includes a positive electrode layer 11, a negative electrode layer 12, and a solid electrolyte layer 13 disposed between the positive electrode layer 11 and the negative electrode layer 12. Between the negative electrode layer 12 and the solid electrolyte layer 13, there is provided a LiZr₂(PO₄)₃-containing layer 14. The solid electrolyte layer 13 includes a first solid electrolyte layer 130. As illustrated in FIG. 5, the first solid electrolyte layer 130 includes a number of solid electrolyte grains 15. As illustrated in FIG. 7, the positive electrode layer 11 or the negative electrode layer 12 may include a number of electrode active material grains 16. Preferably, as illustrated in FIG. 8, the positive electrode layer 11 or the negative electrode layer 12 may include a mixture of a number of the solid electrolyte grains 15 and the electrode active material grains 16.

### Embodiment 1-b

As illustrated in FIG. 2, in a structural example (b) of the solid battery according to Embodiment 1 of the present invention, the solid battery 10 includes the positive electrode layer 11, the negative electrode layer 12, and the solid electrolyte layer 13 disposed between the positive electrode layer 11 and the negative electrode layer 12. The LiZr₂(PO₄)₃-containing layer 14 is provided between the positive electrode layer 11 and the solid electrolyte layer 13. The solid electrolyte layer 13 includes the first solid electrolyte layer 130. As illustrated in FIG. 5, the first solid electrolyte layer 130 includes a number of the solid electrolyte grains 15. As illustrated in FIG. 7, the positive electrode layer 11 or the negative electrode layer 12 may include a number of the electrode active material grains 16. Preferably, as illustrated in FIG. 8, the positive electrode layer 11 or the negative electrode layer 12 may include the mixture of a number of the solid electrolyte grains 15 and the electrode active material grains 16.

### Embodiment 1-c

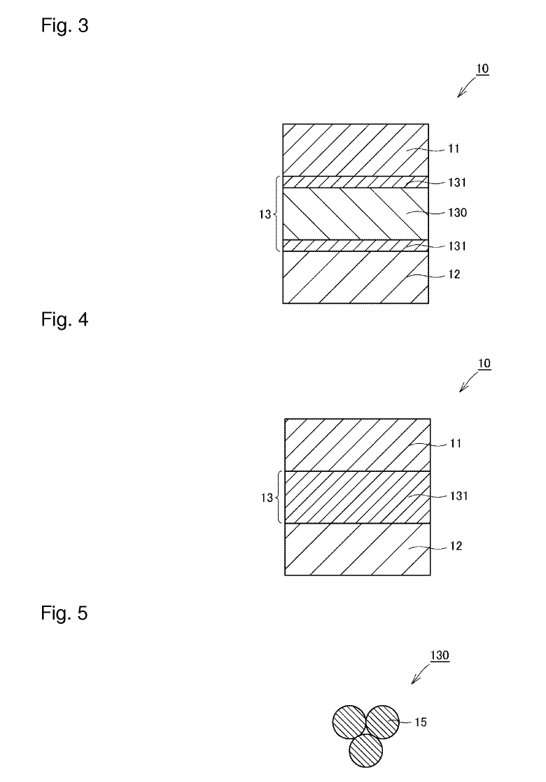

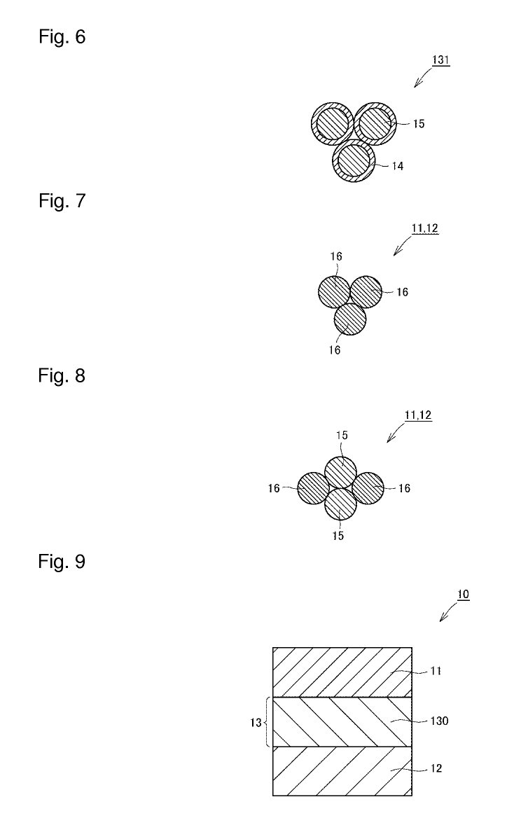

As illustrated in FIG. 3, in a structural example (c) of the solid battery according to Embodiment 1 of the present invention, the solid battery 10 includes the positive electrode layer 11, the negative electrode layer 12, and the solid electrolyte layer 13 disposed between the positive electrode layer 11 and the negative electrode layer 12. The solid electrolyte layer 13 includes the (first) solid electrolyte layer 130 and two second solid electrolyte layers 131 provided on both sides of the first solid electrolyte layer 130. In other words, the second solid electrolyte layers 131 are provided between the first solid electrolyte layer 130 and at least one of the positive electrode layer 11 and the negative electrode layer 12. As illustrated in FIG. 5, the first solid electrolyte layer 130 includes a number of the solid electrolyte grains 15. As illustrated in FIG. 6, the second solid electrolyte layer 131 includes a number of the solid electrolyte grains 15 coated with the LiZr₂(PO₄)₃-containing layer 14. As illustrated in FIG. 7, the positive electrode layer 11 or the negative electrode layer 12 may include a number of the electrode active material grains 16. Preferably, as illustrated in FIG. 8, the positive electrode layer 11 or the negative electrode layer 12 may include the mixture of a number of the solid electrolyte grains 15 and the electrode active material grains 16.

### Embodiment 1-d

As illustrated in FIG. 4, in a structural example (d) of the solid battery according to Embodiment 1 of the present invention, the solid battery 10 includes the positive electrode layer 11, the negative electrode layer 12, and the solid electrolyte layer 13 disposed between the positive electrode layer 11 and the negative electrode layer 12. The solid electrolyte layer 13 includes the second solid electrolyte layer 131. As illustrated in FIG. 6, the second solid electrolyte layer 131 includes a number of the solid electrolyte grains 15 coated with the LiZr₂(PO₄)₃-containing layer 14. As illustrated in FIG. 7, the positive electrode layer 11 or the negative electrode layer 12 may include a number of the electrode active material grains 16. Preferably, as illustrated in FIG. 8, the positive electrode layer 11 or the negative electrode layer 12 may include the mixture of a number of the solid electrolyte grains 15 and the electrode active material grains 16.

In the solid battery 10 according to Embodiment 1 as described above, the LiZr₂(PO₄)₃-containing layer 14 is provided on at least a part of a surface of the solid electrolyte grains 15 included in the solid electrolyte layer 13. Thus, the LiZr₂(PO₄)₃-containing layer 14 exists between the electrode active material grains 16 included in the positive electrode layer 11 or the negative electrode layer 12 and the solid electrolyte grains 15 included in the solid electrolyte layer 13. Accordingly, reduction of the solid electrolyte by the electrode active material can be restrained. As a result, the solid battery 10 having high stability can be manufactured.

In the structural example (a) or (b) illustrated in FIG. 1 or 2, the LiZr₂(PO₄)₃-containing layer 14 is present between the solid electrolyte layer 13 and at least one of the positive electrode layer 11 and the negative electrode layer 12. Thus, reaction at an interface between the solid electrolyte layer 13 and at least one of the positive electrode layer 11 and the negative electrode layer 12 is restrained, so that a solid battery having high stability can be obtained.

### Embodiment 2

### Embodiment 2-a

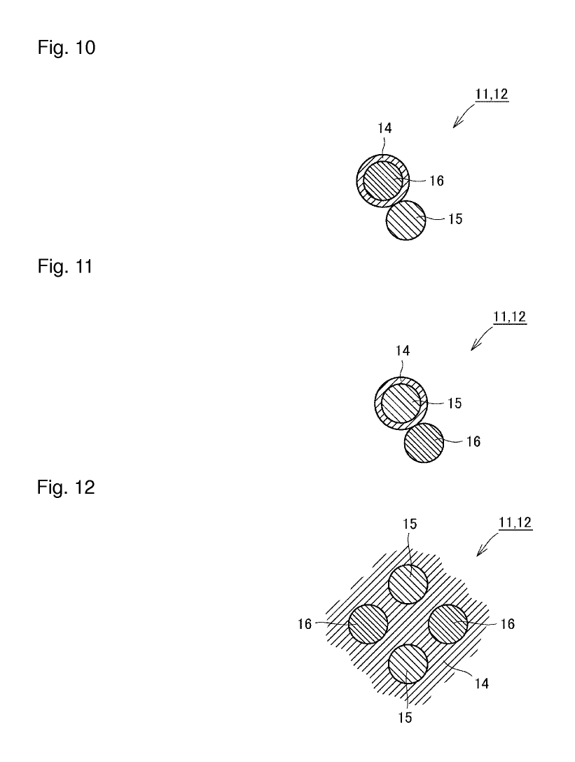

As illustrated in FIG. 9, in a structural example (a) of the solid battery according to Embodiment 2 of the present invention, a solid battery 10 includes a positive electrode layer 11, a negative electrode layer 12, and a solid electrolyte layer 13 disposed between the positive electrode layer 11 and the negative electrode layer 12. The solid electrolyte layer 13 includes a first solid electrolyte layer 130. As illustrated in FIG. 5, the first solid electrolyte layer 130 includes a number of the solid electrolyte grains 15. As illustrated in FIG. 10, the positive electrode layer 11 or the negative electrode layer 12 may include a number of the solid electrolyte grains 15 and the electrode active material grains 16, and the surface of the electrode active material grains 16 may be coated with the LiZr₂(PO₄)₃-containing layer 14. Alternatively, as illustrated in FIG. 11, the positive electrode layer 11 or the negative electrode layer 12 may include a number of the solid electrolyte grains 15 and the electrode active material grains 16, and the surface of the solid electrolyte grains 15 may be coated with the LiZr₂(PO₄)₃-containing layer 14. Alternatively, as illustrated in FIG. 12, the positive electrode layer 11 or the negative electrode layer 12 may include a number of the solid electrolyte grains 15 and the active material grains 16, and the LiZr₂(PO₄)₃-containing layer 14 may be present in such a manner as to fill regions between the solid electrolyte grains 15 and the electrode active material grains 16.

### Embodiment 2-b

As illustrated in FIG. 4, in a structural example (b) of the solid battery according to Embodiment 2 of the present invention, the solid battery 10 includes the positive electrode layer 11, the negative electrode layer 12, and the solid electrolyte layer 13 disposed between the positive electrode layer 11 and the negative electrode layer 12. The solid electrolyte layer 13 includes the second solid electrolyte layer 131. As illustrated in FIG. 6, the second solid electrolyte layer 131 includes a number of the solid electrolyte grains 15 coated with the LiZr₂(PO₄)₃-containing layer 14. As illustrated in FIG. 10, the positive electrode layer 11 or the negative electrode layer 12 may include a number of the solid electrolyte grains 15 and the electrode active material grains 16, and the surface of the electrode active material grains 16 may be coated with the LiZr₂(PO₄)₃-containing layer 14. Alternatively, as illustrated in FIG. 11, the positive electrode layer 11 or the negative electrode layer 12 may include a number of the solid electrolyte grains 15 and the electrode active material grains 16, and the surface of the solid electrolyte grains 15 may be coated with the LiZr₂(PO₄)₃-containing layer 14. Alternatively, as illustrated in FIG. 12, the positive electrode layer 11 or the negative electrode layer 12 may include a number of the solid electrolyte grains 15 and the electrode active material grains 16, and the LiZr₂(PO₄)₃-containing layer 14 may be present in such a manner as to fill the regions between the solid electrolyte grains 15 and the electrode active material grains 16.

In the solid battery 10 according to Embodiment 2 as described above, the LiZr₂(PO₄)₃-containing layer 14 is provided on at least a part of the surface of at least one of the electrode active material grains 16 and the solid electrolyte grains 15 included in at least one of the positive electrode layer 11 and the negative electrode layer 12. Thus, when an electrode layer is formed by mixing the solid electrolyte and the electrode active material, the LiZr₂(PO₄)₃-containing layer 14 is present between the electrode active material grains 16 and the solid electrolyte grains 15 in at least one of the positive electrode layer 11 and the negative electrode layer 12. Accordingly, reduction of the solid electrolyte by the electrode active material can be restrained in at least one of the positive electrode layer 11 and the negative electrode layer 12. As a result, the solid battery 10 having high stability can be manufactured.

Next, specific structural examples of the solid battery according to the present invention will be described.

### Specific Structural Example 1

LTO powder and fine powder of LiZr₂(PO₄)₃ are processed by a mechanical milling apparatus. By this process, the surface of LTO grains are coated with the fine powder of LiZr₂(PO₄)₃. The surface-processed LTO powder is used as a negative electrode active material. The negative electrode active material is mixed with an LATP, which is a solid electrolyte of the NASICON-type structure. By adding a binder and a solvent to the mixture, slurry is prepared. From the slurry, a negative electrode green sheet is prepared.

On the other hand, slurry is prepared by adding a binder and a solvent to the LATP, i.e., the solid electrolyte of the NASICON-type structure. From the slurry, an electrolyte green sheet is prepared.

Further, lithium manganese oxide having a spinel-type structure as a positive electrode active material is mixed with the LATP, which is the solid electrolyte of the NASICON-type structure. To the mixture, a binder and a solvent are added, thereby preparing slurry. From this slurry, a positive electrode green sheet is prepared.

The negative electrode green sheet, the electrolyte green sheet, and the positive electrode green sheet prepared as described above are layered and thermally processed, whereby a sintered integral solid battery is manufactured.

In the LTO powder that has been surface-processed by mechanical milling, fine-grains of LiZr₂(PO₄)₃ are strongly attached to the LTO grain surfaces. This surface state of the LTO grains is maintained even after the LTO powder is mixed with the solid electrolyte of the NASICON-type structure and the green sheet is prepared from the mixture. In the thermal processing after layering, because the thermal processing temperature is lower than the firing temperature of LiZr₂(PO₄)₃, the fine grains of LiZr₂(PO₄)₃ remain almost the same and are hardly changed. However, there occurs sintering of the solid electrolyte of the NASICON-type structure that exists around the fine grains of LiZr₂(PO₄)₃ and the LTO on the surface of which the LiZr₂(PO₄)₃ fine grains are fixedly attached. At this time, the sintering proceeds from both sides of the LiZr₂(PO₄)₃ layer, and the LiZr₂(PO₄)₃ surfaces are also sintered and thereby integrated with the above materials. As a result, the sintered LiZr₂(PO₄)₃ is interposed between the LTO grains, i.e., the electrode active material, and the solid electrolyte of the NASICON-type structure. This structure prevents the direct bonding of the solid electrolyte of the NASICON-type structure and the electrode active material, so that the solid electrolyte of the NASICON-type structure can be prevented from being reduced by the electrode active material. Thus, a solid battery having high stability can be manufactured.

Specific Structural Example 1 corresponds to Embodiment 2-a. As illustrated in FIG. 9, the solid battery 10 includes the positive electrode layer 11, the negative electrode layer 12, and the solid electrolyte layer 13 disposed between the positive electrode layer 11 and the negative electrode layer 12. The solid electrolyte layer 13 includes the first solid electrolyte layer 130. As illustrated in FIG. 5, the first solid electrolyte layer 130 includes LATP grains as a number of the solid electrolyte grains 15. As illustrated in FIG. 10, the negative electrode layer 12 includes LATP grains as a number of the solid electrolyte grains 15, and LTO grains as a number of the electrode active material grains 16. The surface of the electrode active material grains 16 is coated with the LiZr₂(PO₄)₃-containing layer 14. As illustrated in FIG. 8, the positive electrode layer 11 includes a mixture of LATP grains as a number of the solid electrolyte grains 15 and lithium manganese oxide grains as a number of the electrode active material grains 16.

### Specific Structural Example 2

The precursor used for synthesizing LiZr₂(PO₄)₃ may be prepared by the following method. As starting materials, Zr(OC₄H₉)₄, LiNO₃.H₂O, and NH₄H₂PO₄ are used. These materials are accurately weighed such that the molar ratio of the components of LiZr₂(PO₄)₃ can be achieved. The starting materials, citric acid as a polymer precursor, and distilled water as a solvent are mixed, and a resultant solution is homogenized. Thereafter, a predetermined amount of glycol is added in order to promote polyesterification and polycondensation reactions. At this time, the concentration of metal ion is maintained at 0.20 mol per liter at all times.

A resultant solution is then uniformly applied to the surface of the LATP grains by using a tumbling fluidized bed coater. Thereafter, thermal processing is performed at 500° C., thereby obtaining LATP powder in which the precursor of LiZr₂(PO₄)₃ is formed on the surface of the grains. The surface-processed LATP is used as the solid electrolyte contained in the slurries for preparing the negative electrode layer and the solid electrolyte layer. As the solid electrolyte contained in the slurry for preparing the positive electrode layer, LATP that is not surface-processed is used. By the same method as that of Specific Structural Example 1, a negative electrode green sheet, an electrolyte green sheet, and a positive electrode green sheet are prepared, layered, and then thermally processed, thereby manufacturing a sintered and integrated solid battery.

Specific Structural Example 2 corresponds to Embodiment 2-b. As illustrated in FIG. 4, the solid battery 10 includes the positive electrode layer 11, the negative electrode layer 12, and the solid electrolyte layer 13 disposed between the positive electrode layer 11 and the negative electrode layer 12. The solid electrolyte layer 13 includes the second solid electrolyte layer 131. As illustrated in FIG. 6, the second solid electrolyte layer 131 includes LATP grains as a number of the solid electrolyte grains 15 coated with the LiZr₂(PO₄)₃-containing layer 14. As illustrated in FIG. 11, the negative electrode layer 12 includes LATP grains as a number of the solid electrolyte grains 15, and LTO grains as a number of the electrode active material grains 16. The surface of the solid electrolyte grains 15 is coated with the LiZr₂(PO₄)₃-containing layer 14. As illustrated in FIG. 8, the positive electrode layer 11 includes a mixture of LATP grains as a number of the solid electrolyte grains 15, and lithium manganese oxide grains as a number of the electrode active material grains 16.

### Specific Structural Example 3

Slurry is prepared by adding a binder and a solvent to an LTO. From the slurry, a negative electrode green sheet is prepared. By adding a binder and a solvent to an LATP, slurry is prepared. From this slurry, an electrolyte green sheet is prepared. By adding a binder and a solvent into LiZr₂(PO₄)₃, slurry is prepared. From this slurry, a LiZr₂(PO₄)₃ green sheet is prepared. By adding a binder and a solvent to lithium manganese oxide, slurry is prepared. From this slurry, a positive electrode green sheet is prepared. By the same method as that of Specific Structural Example 1, the negative electrode green sheet, the electrolyte green sheet, the LiZr₂(PO₄)₃ green sheet, and the positive electrode green sheet are layered and then thermally processed, thereby manufacturing a sintered and integrated solid battery.

Specific Structural Example 3 corresponds to Embodiment 1-b. As illustrated in FIG. 2, the solid battery 10 includes the positive electrode layer 11, the negative electrode layer 12, and the solid electrolyte layer 13 disposed between the positive electrode layer 11 and the negative electrode layer 12. The LiZr₂(PO₄)₃-containing layer 14 is disposed between the positive electrode layer 11 and the solid electrolyte layer 13. The solid electrolyte layer 13 includes the first solid electrolyte layer 130. As illustrated in FIG. 5, the first solid electrolyte layer 130 includes LATP grains as a number of the solid electrolyte grains 15. As illustrated in FIG. 7, the positive electrode layer 11 includes lithium manganese oxide grains as a number of electrode active material grains 16. The negative electrode layer 12 includes LTO grains as a number of the electrode active material grains 16.

It should be appreciated that the embodiments illustrated herein are illustrative in all respects and should not be taken in a limitative sense. The scope of the present invention is not limited to any of the foregoing embodiments and is defined by the following claims. It is intended that modifications and variations may be made within the scope of the claims and equivalents thereof.

According to the present invention, reduction resistance of a solid electrolyte can be improved, so that a solid battery having high stability can be manufactured.

### DESCRIPTION OF REFERENCE SYMBOLS

10: Solid battery
11: Positive electrode layer
12: Negative electrode layer
13: Solid electrolyte layer
14: LiZr₂(PO₄)₃-containing layer
15: Solid electrolyte grains
16: Electrode active material grain
130: First solid electrolyte layer
131: Second solid electrolyte layer

1. A solid battery comprising:
a positive electrode layer;
a negative electrode layer; and
a solid electrolyte layer between the positive electrode layer and the negative electrode layer,
wherein at least one of the positive electrode layer and the negative electrode layer include an electrode active material, and
the solid electrolyte layer includes a solid electrolyte and a LiZr₂(PO₄)₃-containing material.

2. The solid battery according to claim 1, wherein the LiZr₂(PO₄)₃-containing material is a LiZr₂(PO₄)₃-containing layer between the solid electrolyte layer and at least one of the positive electrode layer and the negative electrode layer.

3. The solid battery according to claim 1, wherein the solid electrolyte is coated with the LiZr₂(PO₄)₃-containing material.

4. The solid battery according to claim 3, wherein the solid electrolyte layer includes
a first layer including the solid electrolyte, and
a second layer disposed between the first layer and at least one of the positive electrode layer and the negative electrode layer, the second layer including the solid electrolyte coated with the LiZr₂(PO₄)₃-containing material.

5. The solid battery according to claim 1, wherein at least one of the positive electrode layer and the negative electrode layer include the solid electrolyte.

6. The solid battery according to claim 1, wherein the solid electrolyte has a NASICON-type structure expressed by a general expression Li₁₊ₓM^{I}ₓM^{II}₂₋ₓ(PO₄)₃, where M^{I} is Al or Ga, and M^{II} is Ti or Ge.

7. The solid battery according to claim 1, wherein the electrode active material is a lithium-titanium composite oxide having a spinel-type structure.

8. The solid battery according to claim 1, wherein the electrode active material is titanium oxide

9. A solid battery comprising:
a positive electrode layer;
a negative electrode layer; and
a solid electrolyte layer between the positive electrode layer and the negative electrode layer,
wherein at least one of the positive electrode layer and the negative electrode layer include an electrode active material, a solid electrolyte, and a LiZr₂(PO₄)₃-containing material.

10. The solid battery according to claim 9, wherein the LiZr₂(PO₄)₃-containing material is on at least a part of a surface of at least one of the electrode active material and the solid electrolyte of at least one of the positive electrode layer and the negative electrode layer.

11. The solid battery according to claim 9, wherein the LiZr₂(PO₄)₃-containing material is on at least a part of a surface of at least one of the electrode active material and the solid electrolyte of both the positive electrode layer and the negative electrode layer.

12. The solid battery according to claim 9, wherein the LiZr₂(PO₄)₃-containing material is between the electrode active material and the solid electrolyte.

13. The solid battery according to claim 9, wherein a surface of the electrode active material is coated with the LiZr₂(PO₄)₃-containing material.

14. The solid battery according to claim 9, wherein a surface of the solid electrolyte is coated with the LiZr₂(PO₄)₃-containing material.

15. The solid battery according to claim 9, wherein the solid electrolyte is a NASICON-type structure expressed by a general expression Li₁₊ₓM^{I}ₓM^{II}₂₋ₓ(PO₄)₃, where M^{I} is Al or Ga, and M^{II} is Ti or Ge.

16. The solid battery according to claim 9, wherein the electrode active material is a lithium-titanium composite oxide having a spinel-type structure.

17. The solid battery according to claim 9, wherein the electrode active material is titanium oxide.
